(19) United States
(12) Patent Application Publication
(10) Pub. No.: US 2022/0156311 A1
(43) Pub. Date: May 19, 2022

(54) IMAGE RETRIEVAL METHOD AND IMAGE RETRIEVAL SYSTEM

(71) Applicant: SEMICONDUCTOR ENERGY LABORATORY CO., LTD., ATSUGI-SHI, KANAGAWA-KEN (JP)

(72) Inventors: Kengo AKIMOTO, Isehara, Kanagawa (JP); Takahiro FUKUTOME, Atsugi, Kanagawa (JP)

(21) Appl. No.: 17/431,824

(22) PCT Filed: Feb. 25, 2020
(86) PCT No.: PCT/IB2020/051577

§ 371 Date: Aug. 18, 2021

(30) Foreign Application Priority Data
Mar. 8, 2019 (JP) 2019-042143

(51) Int. Cl. G06F 16/532; G06F 16/583; G06F 16/538; G06V 10/74; G06V 10/40; G06V 10/82

(52) U.S. Cl. CPC G06F 16/532; G06F 16/583; G06V 10/82; G06V 10/761; G06V 10/40; G06F 16/538

(57) ABSTRACT

Image retrieval is facilitated. An image retrieval device is a device for retrieving an image with high similarity that is stored in a server computer by using a query image. In an image registration mode, a plurality of first images are supplied to a code generation portion, and the code generation portion resizes the number of pixels of the first image, converts the number of pixels of the first image into the number of pixels of a second image, and extracts a first feature value from the second image. The control portion links the first image to the first feature value corresponding to the first image and stores the first image and the first feature value in a storage portion. In an image selection mode, a first query image is supplied to the code generation portion, and the code generation portion resizes the number of pixels of the first query image, converts the number of pixels of the first query image into the number of pixels of a second query image, and extracts a third feature value from the second query image. The first image having the first feature value with high similarity with the second feature value is selected by an image selection portion, and the selected image is used as a query response.

### TECHNICAL FIELD

One embodiment of the present invention relates to an image retrieval method, an image retrieval system, an image registration method, an image retrieval device, an image retrieval database, and a program each utilizing a computer device.

### BACKGROUND ART

A user sometimes retrieves an image with high similarity from images stored in a database. For example, in the case of industrial production equipment, when an image with high similarity with a manufacturing failure image is retrieved, a cause for equipment malfunction occurred in the past can be retrieved easily. In addition, in the case where a different user wants to know an object name or the like, the user sometimes performs retrieval using pictures taken by himself/herself. When a similar image is retrieved from images stored in a database and is displayed, the user can easily know a retrieval object name or the like.

In recent years, image matching using template matching has been known. Patent Document 1 has disclosed an image matching device where predicted fluctuations are added to model images, feature values are extracted from these fluctuation images, and a template that reflects the feature values appearing under various fluctuations is used.

### PRIOR ART DOCUMENT

### Patent Document

[Patent Document 1] Japanese Published Patent Application No. 2015-7972

### SUMMARY OF THE INVENTION

### Problems to be Solved by the Invention

In recent years, databases are constructed in server computers connected to networks in many cases. A variety of programs are stored in the server computers. In order that the programs can each provide a different function, arithmetic processing is performed using a processor. For example, there is a problem in that when the amount of arithmetic processing in a server computer increases, arithmetic processing capability of the entire server computer decreases. In addition, there is a problem in that due to data transmission and reception through a network, when the amount of data transmission and reception through the network increases, the server computer is brought into a congestion state.

Furthermore, there is a problem in that the number of pixels of an image obtained by a user (or industrial production equipment) differs from the number of pixels of an image stored in a database.

When the number of images stored in the database increases, the number of retrieval objects required by the user increases; thus, the possibility of detecting an image with high similarity increases. Note that when the number of retrieval objects increases, the amount of arithmetic processing for calculating the similarity through image comparison increases on a proportional basis. Accordingly, there is a problem of a decrease in the arithmetic processing capability of the server computer. Note that arithmetic processing capability may also be referred to as arithmetic processing speed.

In view of the above problems, an object of one embodiment of the present invention is to provide a novel image retrieval method or image retrieval system utilizing a computer device. An object of one embodiment of the present invention is to provide an image registration method in which a feature value is extracted from an image and the feature value and the image are stored in a database. An object of one embodiment of the present invention is to provide an image registration method in which in the case where arithmetic processing capability of a server computer has a margin, a feature value is extracted from an image stored in a database and the feature value and the image that are linked to each other are stored in the database. An object of one embodiment of the present invention is to provide an image retrieval method in which a feature value is extracted from an image specified by a user and an image with high similarity is selected through comparison between the extracted feature value and a feature value of an image stored in a database. An object of one embodiment of the present invention is to provide an image retrieval method in which the amount of arithmetic processing of a server computer is decreased through comparison between feature values of images and thus a decrease in the arithmetic processing speed of the server computer is suppressed.

Note that the description of these objects does not preclude the existence of other objects. Note that one embodiment of the present invention does not have to achieve all these objects. Note that objects other than these will be apparent from the description of the specification, the drawings, the claims, and the like, and objects other than these can be derived from the description of the specification, the drawings, the claims, and the like.

### Means for Solving the Problems

One embodiment of the present invention is an image retrieval method for retrieving an image with high similarity by using a query image. The image retrieval method is performed using a control portion, a code generation portion, an image selection portion, and a storage portion. The image retrieval method includes an image registration mode and an image selection mode. The image registration mode includes a step of supplying a first image to the code generation portion; a step in which the code generation portion resizes the number of pixels of the first image and converts the number of pixels of the first image into the number of pixels of a second image; a step in which the code generation portion extracts a first feature value from the second image; and a step in which the control portion links the first image to the first feature value corresponding to the first image and stores the first image and the first feature value in the storage portion. The image selection mode includes a step of supplying a first query image to the code generation portion; a step in which the code generation portion resizes the number of pixels of the first query image and converts the number of pixels of the first query image into the number of pixels of a second query image; a step in which the code generation portion extracts a second feature value from the second query image; and a step in which the image selection portion selects the first image having the first feature value with high similarity with the second feature value and displays the selected first image or a list of the selected first images as a query response.

One embodiment of the present invention is an image retrieval method for retrieving an image with high similarity by using a query image. The image retrieval method is performed using a control portion, a code generation portion, an image selection portion, and a storage portion. The image retrieval method includes an image registration mode and an image selection mode. The image selection mode includes a first selection mode and a second selection mode. The image registration mode includes a step of supplying a first image to the code generation portion; a step in which the code generation portion resizes the number of pixels of the first image, converts the number of pixels of the first image into the number of pixels of a second image, and extracts a first feature value from the second image; a step in which the code generation portion resizes the number of pixels of the first image, converts the number of pixels of the first image into the number of pixels of a third image, and extracts a second feature value from the third image; and a step in which the control portion links the first image to the first feature value and the second feature value corresponding to the first image and stores the first image, the first feature value, and the second feature value in the storage portion. The image selection mode includes a step of supplying a first query image to the code generation portion; a step in which the code generation portion resizes the number of pixels of the first query image, converts the number of pixels of the first query image into the number of pixels of a second query image, and extracts a third feature value from the second query image; a step in which the code generation portion resizes the number of pixels of the first query image, converts the number of pixels of the first query image into the number of pixels of a third query image, and extracts a fourth feature value from the second query image; and a step of executing the first selection mode and the second selection mode. The first selection mode includes a step in which the image selection portion compares the third feature value and the first feature value and a step in which the image selection portion selects the plurality of first images each having the first feature value with high similarity with the third feature value. The second selection mode includes a step in which the image selection portion compares the fourth feature value and the second feature value of the plurality of first images selected in the first selection mode. The image selection mode includes a step in which the control portion displays the first image having the highest similarity with the fourth feature value or a list of the plurality of first images each having high similarity as a query response.

In the above structure, the number of pixels of the third image is preferably larger than the number of pixels of the second image.

In the above structure, the code generation portion preferably includes a convolutional neural network.

In the above structure, the convolutional neural network included in the code generation portion includes a plurality of max pooling layers. The first feature value or the second feature value is preferably an output of any one of the plurality of max pooling layers.

In the above structure, the convolutional neural network includes a plurality of fully connected layers. The first feature value or the second feature value is preferably an output of any one of the plurality of max pooling layers or an output of any one of the plurality of fully connected layers.

An image retrieval system includes, in a server computer, a memory for storing a program for performing the image retrieval method described in any one of the above structures and a processor for executing the program.

An image retrieval system includes a memory for storing a program for performing the image retrieval method described in any one of the above structures, and the query image is supplied from an information terminal through a network.

One embodiment of the present invention is an image retrieval system operating on a server computer. An image is registered in the server computer through a network. The image retrieval system includes a control portion, a code generation portion, a database, and a load monitoring monitor. The load monitoring monitor has a function of monitoring arithmetic processing capability of the server computer. The image retrieval system has a first function and a second function. In the case where the arithmetic processing capability has no margin, the first function makes the control portion register the image supplied through the network in the database. In the case where the arithmetic processing capability has a margin, the second function makes the code generation portion extract a feature value from the image and makes the control portion register the image and the feature value corresponding to the image in the database. Alternatively, the second function makes the control portion extract the feature value of the image that has not been registered from the image that has been registered in the database and makes the control portion register the feature value of the image in the database.

### Effect of the Invention

According to one embodiment of the present invention, it is possible to provide a novel image retrieval method utilizing a computer device. According to one embodiment of the present invention, it is possible to provide an image registration method in which a feature value is extracted from an image and the feature value and the image are stored in a database. According to one embodiment of the present invention, it is possible to provide an image registration method in which in the case where arithmetic processing capability of a server computer has a margin, a feature value is extracted from an image stored in a database and the feature value and the image that are linked to each other are stored in the database. According to one embodiment of the present invention, it is possible to provide an image retrieval method in which a feature value is extracted from an image specified by a user and an image with high similarity is selected through comparison between the extracted feature value and a feature value of an image stored in a database. According to one embodiment of the present invention, it is possible to provide an image retrieval method in which the amount of arithmetic processing of a server computer is decreased through comparison between feature values of images and thus a decrease in the arithmetic processing speed of the server computer is suppressed.

Note that the effects of one embodiment of the present invention are not limited to the effects listed above. The effects listed above do not preclude the existence of other effects. Note that the other effects are effects that are not described in this section and will be described below. The other effects that are not described in this section will be derived from the description of the specification, the drawings, and the like and can be extracted from the description by those skilled in the art. Note that one embodiment of the present invention is to have at least one of the effects listed above and/or the other effects. Accordingly, depending on the case, one embodiment of the present invention does not have the effects listed above in some cases.

### BRIEF DESCRIPTION OF THE DRAWINGS

FIG. 1 is a block diagram illustrating an image retrieval method.

FIG. 2 is a block diagram illustrating an image retrieval device.

FIG. 3 is a block diagram illustrating an image registration method.

FIG. 4 is a flow chart showing the image registration method.

FIG. 5A, FIG. 5B, FIG. 5C, and FIG. 5D are diagrams each showing a code generation portion.

FIG. 6 is a diagram showing a database structure.

FIG. 7 is a flow chart showing an image selection mode.

FIG. 8 is a flow chart showing the image selection mode.

FIG. 9 is a block diagram illustrating an image retrieval method.

### MODE FOR CARRYING OUT THE INVENTION

Embodiments will be described in detail with reference to the drawings. Note that the present invention is not limited to the following description, and it will be readily understood by those skilled in the art that modes and details of the present invention can be modified in various ways without departing from the spirit and scope of the present invention. Therefore, the present invention should not be construed as being limited to the description of embodiments below.

Note that in structures of the present invention described below, the same reference numerals are used in common for the same portions or portions having similar functions in different drawings, and a repeated description thereof is omitted. Moreover, similar functions are denoted by the same hatch pattern and are not denoted by specific reference numerals in some cases.

In addition, the position, size, range, or the like of each structure illustrated in drawings does not represent the actual position, size, range, or the like in some cases for easy understanding. Therefore, the disclosed invention is not necessarily limited to the position, size, range, or the like disclosed in the drawings.

### (Embodiment)

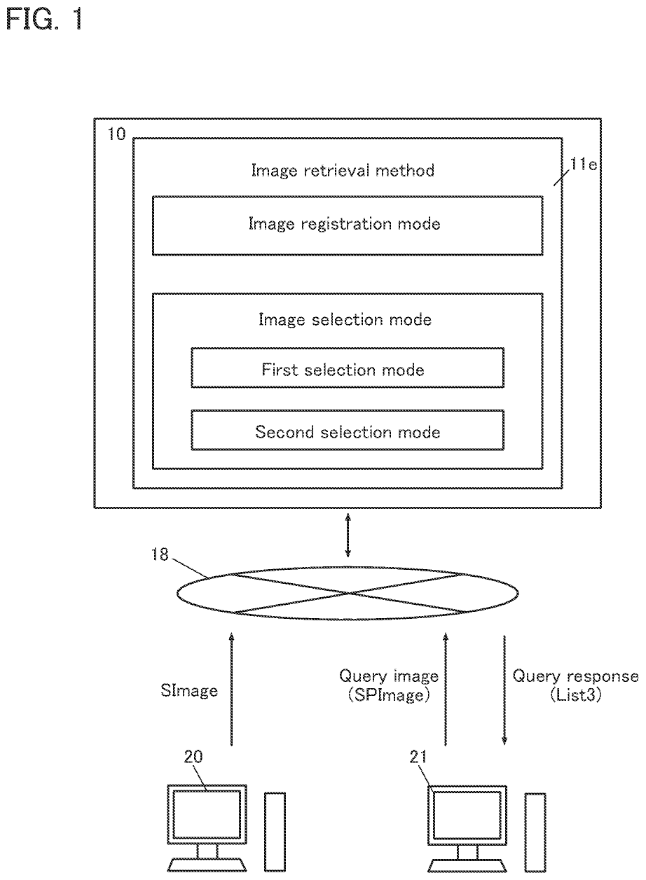

In this embodiment, image retrieval methods will be described using FIG. 1 to FIG. 9.

The image retrieval method described in this embodiment is controlled by a program that operates on a server computer. Accordingly, the server computer can also be referred to as an image retrieval device (also referred to as an image retrieval system) with an image retrieval method. The program is stored in a memory included in the server computer or a storage. Alternatively, the program is stored in a server computer including a database that is connected via a network (LAN (Local Area Network), WAN (Wide Area Network), the Internet, or the like).

A query image is supplied to the image retrieval device (the server computer) from a computer (also referred to as a local computer) or an information terminal via wired communication or wireless communication. The server computer can extract an image with high similarity with the query image from images stored in the database included in the server computer. In the case where the image with high similarity is retrieved, a convolutional neural network (CNN), pattern matching, or the like is preferably used for the image retrieval method. In this embodiment, an example of using a CNN is described.

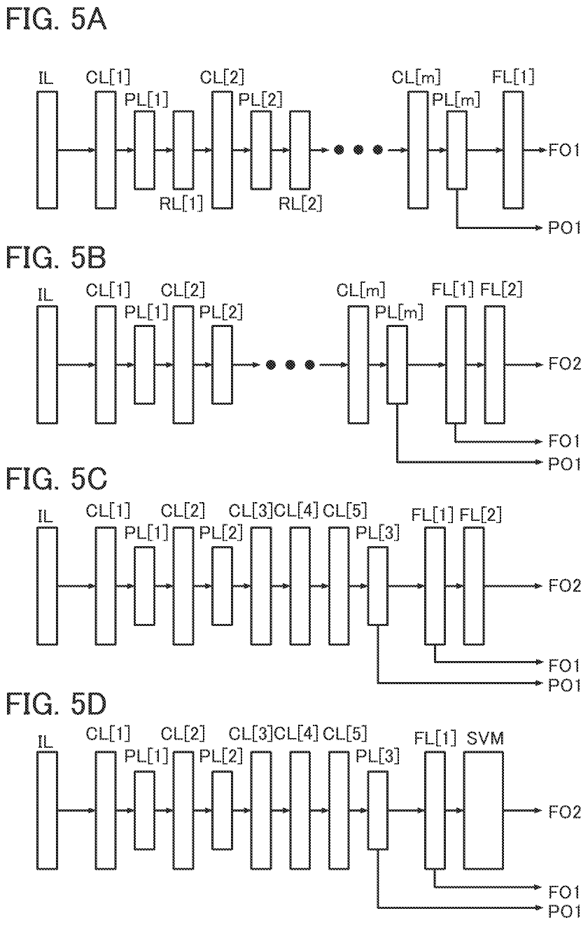

The CNN is composed of a combination of several distinctive functional layers such as a plurality of convolutional layers and a plurality of pooling layers (for example, max pooling layers). Note that the CNN is one of the algorithms with excellent image recognition. For example, the convolutional layer is suitable for feature value extraction such as edge extraction from an image. In addition, the max pooling layer has a function of providing robustness so that a feature extracted by the convolutional layer is not affected by parallel translation or the like. Accordingly, the max pooling layer has a function of suppressing influence of positional information on a feature value extracted by the convolutional layer. The CNN will be described in detail in FIG. 5.

The image retrieval device includes a control portion, a code generation portion, an image selection portion, and a storage portion. Note that the image retrieval method includes an image registration mode and an image selection mode. The image selection mode includes a first selection mode and a second selection mode. Note that the code generation portion includes a CNN.

In the image registration mode, a first image is supplied to the code generation portion. Note that the image registration mode included in the image retrieval method may also be referred to as an image registration method for constructing an image retrieval database. The number of pixels of the first image is resized and converted into the number of pixels of a second image by the code generation portion. A first feature value is extracted from the second image by the code generation portion. The number of pixels of the first image is resized and converted into the number of pixels of a third image by the code generation portion. A second feature value is extracted from the third image by the code generation portion. The first image is linked to the first feature value and the second feature value corresponding to the first image, and the first image, the first feature value, and the second feature value are stored in the storage portion by the control portion. Note that the storage portion includes a database, and the first image and the first feature value and the second feature value corresponding to the first image that are linked to each other are preferably stored in the database. The first image can also be referred to as learning data stored in the database.

The number of pixels of the third image is preferably larger than the number of pixels of the second image. Note that it is preferable not to limit the number of pixels of the first image. This means that the second feature value extracted from the third image becomes larger than the first feature value extracted from the second image. For example, in the case where the number of pixels of the second image is 100 pixels in a longitudinal direction and 100 pixels in a lateral direction, the first feature value can be expressed by 9216 (=96×96) numbers. As another example, in the case where the number of pixels of the third image is 300 pixels in the longitudinal direction and 300 pixels in the lateral direction, the second feature value can be expressed by 82944 (288×288) numbers. In other words, the second feature value is approximately nine times as large as that of the first feature value. Note that the number of pixels of the second image or the number of the first feature values extracted by the number of pixels of the second image is not limited, and the number of pixels of the third image or the number of the second feature value extracted by the number of pixels of the third image is not limited.

In addition, it is preferable not to limit the number of pixels of the first image. For example, even when the number of pixels of the first image differs, comparison using the first feature value extracted from the number of pixels of the second image is easy. In other words, the first feature value is a normalized feature value of an image with a different number of pixels. Accordingly, the use of the first feature value can construct a database that can easily retrieve a target image from high-volume image data. Note that in the case where image feature values are compared in detail, the second feature value generated from the third image is suitable for detailed comparison of image feature values because the second feature value is larger than the first feature value.

Next, the case where a first query image is supplied to the code generation portion from an information terminal, a computer, or the like through a network is described.

In the image selection mode, the first query image is supplied to the code generation portion. The number of pixels of the first query image is resized and converted into the number of pixels of a second query image, and a third feature value is extracted from the second query image by the code generation portion. Next, the number of pixels of the first query image is resized and converted into the number of pixels of a third query image, and a fourth feature value is extracted from the third query image by the code generation portion. Note that the number of pixels of the second query image is the same as the number of pixels of the second image, and the number of pixels of the third query image is the same as the number of pixels of the third image. Note that the first query image can be registered as learning data.

The image selection portion in the first selection mode selects a plurality of first images each having the first feature value with high similarity with the third feature value.

The image selection portion in the second selection mode compares the fourth feature value and the second feature value of the plurality of first images selected in the first selection mode. The control portion displays the first image having the highest similarity with the fourth feature value or a list of the plurality of first images each having high similarity as a query response. Note that in the list, top n images with high similarities out of the plurality of first images selected in the first selection mode can be set as a selection range. Note that it is preferable that the selection range can be set by a user. Note that n is an integer greater than or equal to 1.

In addition, the CNN can further include a plurality of fully connected layers. The fully connected layer has a function of classifying CNN outputs. Thus, an output of the convolutional layer can be supplied to the max pooling layer, the convolutional layer, the fully connected layer, or the like. Note that in order to reduce the influence of positional information from edge information or the like extracted by the convolutional layer, the max pooling layer preferably processes the output of the convolutional layer. Note that a filter can be provided for the convolutional layer. When the filter is provided, gradation such as edge information can be clearly extracted depending on a feature. Accordingly, an output of the max pooling layer is suitable for comparison of image features. As a result, the output of the max pooling layer can be used for the first feature value to the fourth feature value. Note that the filter corresponds to a weight coefficient in a neural network.

For example, the CNN can include a plurality of max pooling layers. The first feature value to the fourth feature value can express image features more precisely when any one of the outputs of the plurality of max pooling layers is used. Alternatively, the first feature value to the fourth feature value can use any one of the outputs of the max pooling layers and any one of the outputs of the fully connected layers. Furthermore, when the output of the max pooling layer and the output of the fully connected layer are used, image features can be extracted. When the output of the fully connected layer is added to the first feature value to the fourth feature value, an image with high similarity can be selected from the database.

Note that as a method for comparing similarities of the first feature value to the fourth feature value, there is a method for measuring the direction or distance of a comparison target. For example, there are cosine similarity, Euclidean distance, standard Euclidean distance, Mahalanobis distance, and the like. Note that arithmetic processing of the CNN, the first selection mode, or the second selection mode is achieved by a circuit (hardware) or a program (software). Accordingly, the server computer preferably includes a memory for storing a program for performing the image retrieval method and a processor executing the program.

As described above, one embodiment of the present invention may also be referred to as an image retrieval system that operates on a server computer. For example, the server computer includes a load monitoring monitor, and the load monitoring monitor has a function of monitoring arithmetic processing capability of the server computer.

The program included in the server computer can provide a function or a service to a different computer or an information terminal that is connected to the network. Note that in the case where a plurality of computers or information terminals that are connected to the network access the server computer at the same time, the arithmetic processing capability of the server computer cannot handle the access, and thus the arithmetic processing capability of the server computer decreases. Accordingly, the server computer includes the load monitoring monitor for monitoring the arithmetic processing capability.

For example, in the case where the arithmetic processing capability of the server computer has no margin, the control portion has a function of registering an image supplied through the network in the database without extraction of a feature value from the image.

As another example, in the case where the arithmetic processing capability of the server computer has a margin, the code generation portion has a function of extracting a feature value from the image. The control portion has a function of registering the image and a feature value corresponding to the image in the database. Alternatively, the feature value of the image that has not been registered can be extracted from the image that has been registered in the database and can be registered in the database.

Next, the image retrieval method is described using FIG. 1. Note that in the following description, the image retrieval method is sometimes referred to as an image retrieval device.

An image retrieval device 10 includes a storage portion 11e for storing a program for performing the image retrieval method. Note that the storage portion 11e includes a database. The image retrieval method includes an image registration mode and an image selection mode. The image selection mode includes a first selection mode and a second selection mode.

In the image registration mode, an image can be registered in the database. To make a detailed description, in the image registration mode, an image to be registered and a feature value extracted from the image are linked and registered in the database. Note that an image SImage to be registered is supplied to the image retrieval device 10 from a computer 20 through a network 18. Note that the image SImage to be registered in the database may be supplied from, without being limited to the computer 20, from an information terminal to the image retrieval device 10 through the network 18.

In the image selection mode, a query image SPImage is supplied to the image retrieval device 10 from a computer 21 through the network 18. In the image selection mode, a feature value is extracted from the query image SPImage, and the feature value and a feature value of the image SImage registered in the database are compared, so that an image with high similarity with the query image SPImage is selected.

Note that in the image selection mode, the query image SPImage is resized, and a first query image and a second query image each with a different number of pixels from the number of pixels of the query image SPImage are generated. In addition, the number of pixels of the second query image is preferably different from the number of pixels of the first query image. Note that the number of pixels of the second query image is preferably larger than the number of pixels of the first query image. For example, in the case where the number of pixels of the first query image is smaller than the number of pixels of the second query image, in the first selection mode, the feature value of the first query image and a feature value stored in the database are compared, and a plurality of images with high similarities are selected. Since the number of pixels of the first query image is smaller than the number of pixels of the second query image, database retrieval time can be reduced.

In the second selection mode, the plurality of images with high similarities that are retrieved in the first selection mode are compared with a feature value extracted from the second query image. The image retrieval device 10 compares the feature value extracted from the second query image with feature values of the plurality of images SImage selected in the first selection mode. The image retrieval device 10 displays the image SImage with the highest similarity or a list (List3) of the plurality of images SImage with high similarities as a query response.

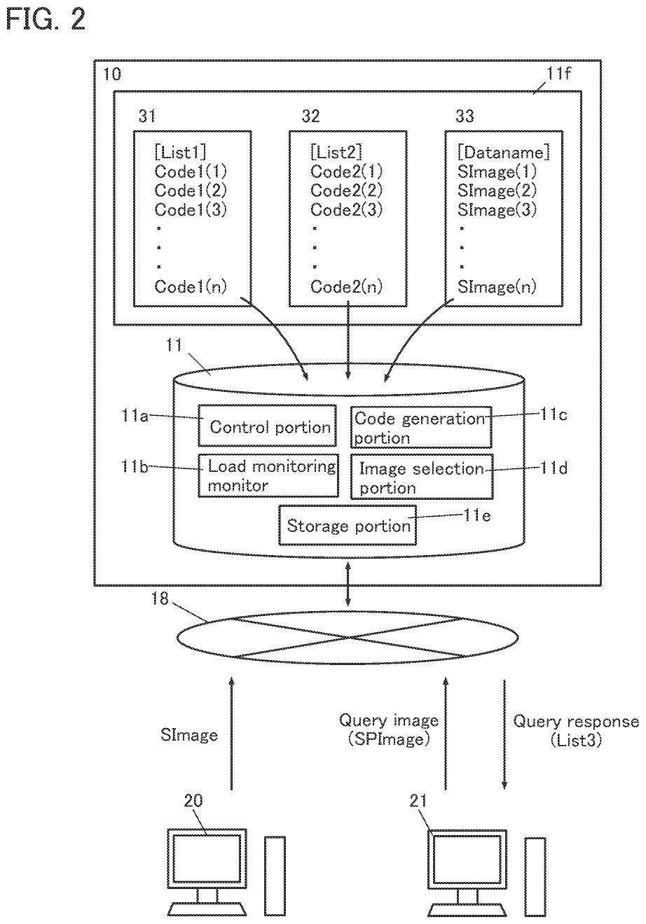

FIG. 2 is a block diagram illustrating the image retrieval method in FIG. 1 in detail.

The image retrieval device 10 can also be referred to as a server computer 11. The server computer 11 is connected to the computer 20 and the computer 21 through the network 18. Note that the number of computers that can be connected to the server computer 11 through the network 18 is not limited. In addition, the server computer 11 may be connected to an information terminal through the network 18. Examples of the information terminal include a smartphone, a tablet terminal, a cellular phone, a laptop, and the like.

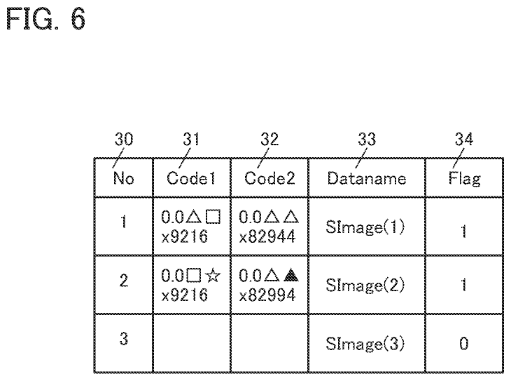

The image retrieval device 10 includes a control portion 11a, a load monitoring monitor 11b, a code generation portion 11c, an image selection portion 11d, and the storage portion 11e. When a program stored in the storage portion 11e is processed by a processor (not illustrated) included in the server computer 11, the image retrieval method can be provided. Note that the storage portion 11e includes a database 11f. The database 11f will be described in detail in FIG. 6. The database 11f keeps a feature value Code1 and a feature value Code2 that are generated by the CNN included in the code generation portion 11c and an image file name supplied through the network 18 as a list 31 to a list 33, respectively. The image file name shows a file name of the image SImage. Note that the list 31 (List1), the list 32 (List2), and the list 33 (Dataname) are linked to the first images and registered.

First, the image registration mode is described. In the image registration mode, for example, the image SImage is supplied to the code generation portion 11c from the computer 20 through the network 18. After the number of pixels of the image SImage is resized and converted into the number of pixels of the second image by the code generation portion 11c, the feature value Code1 is extracted from the second image. Next, after the number of pixels of the image SImage is resized and converted into the number of pixels of the third image by the code generation portion 11c, the feature value Code2 is extracted from the third image. The control portion 11a links the image SImage to the feature value Code1 and the feature value Code2 that correspond to the image SImage and stores the image SImage, the feature value Code1, and the feature value Code2 in the database 11f.

Note that the second image or the third image may or may not be registered in the database 11f. In an image retrieval method according to one embodiment of the present invention, image similarity is calculated using the feature value Code1 and the feature value Code2. Accordingly, when the second image or the third image is not stored, the usage of the storage portion 11e can be reduced. The image SImage can be registered as learning data stored in the database 11f.

Next, the image selection mode is described. In the image selection mode, for example, the case where the query image SPImage is supplied to the code generation portion 11c from the computer 21 through the network 18 is described.

After the number of pixels of the query image SPImage is resized and converted into the number of pixels of the second query image by the code generation portion 11c, a feature value Code3 (not illustrated) is extracted from the second query image. Next, after the number of pixels of the query image SPImage is resized and converted into the number of pixels of the third query image by the code generation portion 11c, a feature value Code4 (not illustrated) is extracted from the third query image. Note that the number of pixels of the second query image is the same as the number of pixels of the second image, and the number of pixels of the third query image is the same as the number of pixels of the third image. Note that the first query image can be registered as learning data.

In the first selection mode, the image selection portion 11d selects the plurality of images SImage each having the first feature value with high similarity with the feature value Code3.

The image selection portion 11d in the second selection mode compares the feature value Code4 and the feature values Code2 of the plurality of images SImage selected in the first selection mode. The image SImage having the highest similarity with the feature value Code4 or the list 33 of the plurality of images SImage each having high similarity is displayed as a query response. Note that in the list, top n images with high similarities out of the plurality of images SImage selected in the first selection mode can be set as a selection range. Note that it is preferable that the selection range can be set by the user freely.

As described above, one embodiment of the present invention may also be referred to as an image retrieval system that operates on the server computer 11. For example, the server computer 11 includes the load monitoring monitor 11b, and the load monitoring monitor 11b has a function of monitoring arithmetic processing capability of the server computer 11.

For example, in the case where the arithmetic processing capability of the server computer 11 has no margin, the control portion 11a has a function of registering the image SImage supplied through the network 18 in the database 11f.

As another example, in the case where the arithmetic processing capability of the server computer 11 has a margin, the code generation portion 11c has a function of extracting the feature value Code1 or the feature value Code2 from the image SImage. The control portion 11a has a function of registering the image SImage and the feature value Code1 or the feature value Code2 corresponding to the image SImage in the database 11f. Alternatively, the feature value Code1 or the feature value Code2 of the image SImage that has not been registered can be extracted from the image that has been registered in the database 11f and can be registered in the database 11f.

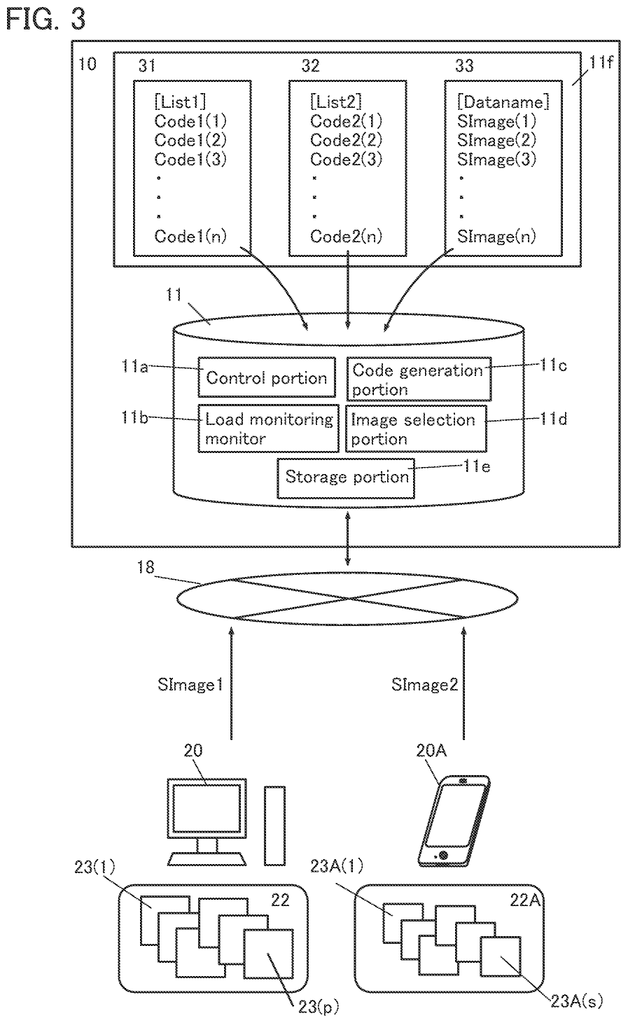

FIG. 3 is a diagram illustrating an image registration method. FIG. 3 illustrates an example where an image SImage1 is registered from the computer 20 that is connected to the network 18 and an image SImage2 is registered from an information terminal 20A.

The computer 20 includes p images (an image 23(1) to an image 23(p)) that are stored in a storage portion 22 included in the computer 20. The information terminal 20A includes s images (an image 23A(1) to an image 23A(s)) that are stored in a storage portion 22A included in an information terminal 21A. FIG. 3 illustrates an example where the number of pixels of an image 23 is larger than the number of pixels of an image 23A; however, the number of pixels of the image 23 may be smaller than the number of pixels of the image 23A, or the number of pixels of the image 23 may be the same as the number of pixels of the image 23A. Accordingly, the number of pixels of the image 23 registered in the database 11f may be different from or the same as the number of pixels of the image 23A. Note that each of p and s is an integer greater than 2.

Note that the control portion 11a in the server computer 11 monitors whether the arithmetic processing capability of the server computer 11 has a margin by using the load monitoring monitor 11b. For example, in the case where the arithmetic processing capability has a margin, the code generation portion 11c extracts the feature value Code1 or the feature value Code2 of the image 23, extracts the feature value Code1 or the feature value Code2 of the image 23A, and registers the image 23 and the feature value Code 1 or the feature value Code 2 of the image 23 that are linked to each other, and the image 23A and the feature value Code 1 or the feature value Code 2 of the image 23A that are linked to each other in the database 11f. In the case where the arithmetic processing capability has no margin, the feature values Code1 and the feature values Code2 are not generated from the image 23 and the image 23A, and the image 23 and the image 23A are registered in the database 11f. Note that in the case where the arithmetic processing capability has a margin, the database 11f is retrieved so that the feature value Code1 or the feature value Code2 is generated using a registered from which the feature value Code1 or the feature value Code2 is not generated and is registered in the database 11f.

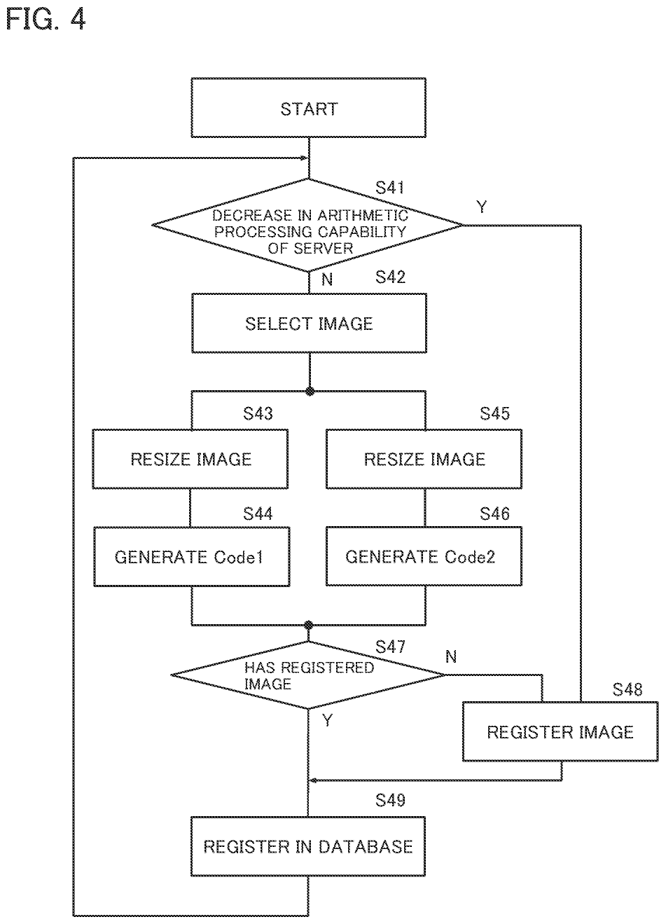

FIG. 4 is a flow chart showing the image registration method in FIG. 3. First, the image SImage1 or the image SImage2 is supplied to the server computer 11 from the computer 20 or the information terminal 21A that is connected to the network. Note that in order to simplify the description, the image SImage1 or the image SImage2 is referred to as the image SImage.

In Step S41, the control portion 11a monitors the arithmetic processing capability of the server computer 11 by using the load monitoring monitor 11b. In the case where the control portion 11a judges that the arithmetic processing capability of the server computer 11 decreases (Y), the process moves to Step S48. In the case where the control portion 11a judges that the arithmetic processing capability of the server computer 11 has a margin (N), the process moves to Step S42.

The case where the control portion 11a judges that the arithmetic processing capability of the server computer 11 decreases is described. In Step S48, the control portion 11a registers the image SImage in the database 11f. Note that the database 11f will be described in detail in FIG. 6.

In Step S49, “0” is registered in a list 34. “0” registered in the list 34 means that neither the feature value Code1 nor the feature value Code2 is generated in Step S48. Note that in the following description, an image where “0” is registered in the list 34 of the database 11f is referred to as an image SImage_A. The process moves to Step S41, and whether there is a new image SImage to be registered in the database 11f is confirmed. Note that the list 34 functions as a flag (Flag) for keeping track of whether a feature value has been extracted. In the case where a feature value has been extracted, “1” is registered in the list 34 as the flag (Flag). In the case where a feature value has not been extracted, “0” is registered as Flag.

Next, the case where the control portion 11a judges that the arithmetic processing capability of the server computer 11 has a margin is described. In Step S42, the image SImage for extracting a feature value by the code generation portion 11c is selected. In the case where there is a new image SImage to be registered in the database 11f, the image SImage is selected. In the case where there is no new image SImage to be registered in the database 11f, the image SImage_A that has been registered in the database 11f is selected. The process moves to Step S43 and Step S45.

In Step S43, the number of pixels of the image SImage is resized and converted into the number of pixels of the second image by the code generation portion 11c. For example, the number of pixels of the second image is converted into 100 pixels in the longitudinal direction and 100 pixels in the lateral direction.

In Step S44, the feature value Code1 is generated from the second image by the code generation portion 11c.

In Step S45, the number of pixels of the image SImage is resized and converted into the number of pixels of the third image by the code generation portion 11c. For example, the number of pixels of the third image is converted into 300 pixels in the longitudinal direction and 300 pixels in the lateral direction.

In Step S46, the feature value Code2 is generated from the third image by the code generation portion 11c.

For example, the server computer 11 can execute a plurality of programs; thus, image resizing processings can be executed in parallel. Note that Step S43, Step S44, Step S45, and Step S46 may be executed consecutively in that order. When these steps are executed consecutively, the decrease in the arithmetic processing capability of the server computer 11 can be suppressed.

In Step S47, whether the image is an image where “0” is registered in the list 34 of the database 11f is judged. In the case where the image SImage_A is registered in the database 11f and the list 34 is “0” (Y), the process moves to Step S48. In other cases (N), the process moves to Step S49.

In Step S49, the feature value Code1, the feature value Code2, and the image SImage that are linked to each other are registered in the database 11f, and “1” is registered in the list 34. The process moves to Step S41, and whether there is a new image SImage to be registered in the database 11f is confirmed.

FIG. 5A to FIG. 5D are diagrams each showing a CNN included in the code generation portion 11c.

FIG. 5A is a CNN that includes an input layer IL, a convolutional layer CL[1] to a convolutional layer CL[m], a pooling layer PL[1] to a pooling layer PL[m], a rectified linear unit RL[1] to a rectified linear unit RL[m−1], and a fully connected layer FL[1]. The input layer IL supplies input data to the convolutional layer CL[1]. The convolutional layer CL[1] supplies first output data to the pooling layer PL[1]. The pooling layer PL[1] supplies second output data to the rectified linear unit RL[1]. The rectified linear unit RL[1] supplies third output data to a convolutional layer CL[2]. Note that m is an integer greater than 2.

FIG. 5A is the CNN where the convolutional layer CL[1], the pooling layer PL[1], and the rectified linear unit RL[1] are regarded as one module and m−1 modules are connected. Note that fourth output data of the m-th pooling layer PL[m] is supplied to the fully connected layer FL[1], and an output FO1 is output from the fully connected layer FL[1]. Note that the output FO1 corresponds to an output label of the CNN and can detect what kind of image the image SImage supplied to the input layer IL is. In the CNN, a weight coefficient to be supplied to a convolutional layer CL is preferably updated by supervised learning.

In FIG. 5A, an output PO1 is output from the pooling layer PL[m]. The pooling layer PL[m] generates a new feature value where the amount of positional information extracted by the convolutional layer CL is reduced and outputs the generated new feature value as the output PO1. Accordingly, the output PO1 corresponds to the feature value Code1 to the feature value Code4. Note that in the case where the feature value Code1 to the feature value Code4 use only the output PO1, a fully connected layer FL is not necessarily provided.

A CNN that is different from the CNN in FIG. 5A is described using FIG. 5B. FIG. 5B is a CNN that includes the input layer IL, the convolutional layer CL[1] to the convolutional layer CL[m], the pooling layer PL[1] to the pooling layer PL[m], the fully connected layer FL[1], and a fully connected layer FL[2]. The input layer IL supplies input data to the convolutional layer CL[1]. The convolutional layer CL[1] supplies the first output data to the pooling layer PL[1]. The pooling layer PL[1] supplies the second output data to the convolutional layer CL[2].

FIG. 5B is the CNN where the convolutional layer CL[1] and the pooling layer PL[1] are regarded as one module and m modules are connected. Note that output data of the m-th pooling layer PL[m] is supplied to the fully connected layer FL[1], data output from the fully connected layer FL[1] is supplied to the fully connected layer FL[2], and an output FO2 is output from the fully connected layer FL[2]. Note that the output FO1 is output from the fully connected layer FL[1]. Note that the output FO2 corresponds to an output label of the CNN and can detect what kind of image the image SImage supplied to the input layer IL is. In the CNN, a weight coefficient to be supplied to the convolutional layer CL is preferably updated by supervised learning.

In FIG. 5B, the output PO1 is output from the pooling layer PL[m]. The output PO1 is a feature value where a feature value is extracted by the convolutional layer CL and positional information of the feature value is reduced. When the feature value is extracted using the output PO1 and the output FO1, the feature value can express features of an input image. Accordingly, the feature value that is generated using the output PO1 or the output FO1 corresponds to the feature value Code1 to the feature value Code4. Note that in the case where the feature value Code1 to the feature value Code4 use only the output PO1, the fully connected layer FL is not necessarily provided.

A CNN that is different from the CNN in FIG. 5B is described using FIG. 5C. FIG. 5C is a CNN that includes the input layer IL, the convolutional layer CL[1] to a convolutional layer CL[5], the pooling layer PL[1] to a pooling layer PL[3], the fully connected layer FL[1], and the fully connected layer FL[2]. Note that the number of convolutional layers CL and the number of pooling layers PL are not limited, and the number of convolutional layers CL and the number of pooling layers PL can be increased or decreased as needed.

The input layer IL supplies input data to the convolutional layer CL[1]. The convolutional layer CL[1] supplies the first output data to the pooling layer PL[1]. The pooling layer PL[1] supplies the second output data to the convolutional layer CL[2]. The convolutional layer CL[2] supplies fifth output data to a pooling layer PL[2]. The pooling layer PL[2] supplies sixth output data to a convolutional layer CL[3]. The convolutional layer CL[3] supplies seventh output data to a convolutional layer CL[4]. The convolutional layer CL[4] supplies eighth output data to the convolutional layer CL[5]. The convolutional layer CL[5] supplies ninth output data to the pooling layer PL[3]. Tenth output data of the pooling layer PL[3] is supplied to the fully connected layer FL[1]. The fully connected layer FL[1] supplies eleventh output data to the fully connected layer FL[2]. The output FO2 is output from the fully connected layer FL[2].

In FIG. 5C, the output PO1 is output from the pooling layer PL[3]. The output PO1 is a feature value where a feature value is extracted by the convolutional layer CL and positional information of the feature value is reduced. Accordingly, the output PO1 corresponds to the feature value Code1 to the feature value Code4. Alternatively, the feature value that is generated using the output PO1, the output FO1, or the output FO2 may be the feature value Code1 to the feature value Code4. Note that in the case where the feature value Code1 to the feature value Code4 use only the output PO1, the fully connected layer FL is not necessarily provided.

A CNN that is different from the CNN in FIG. 5C is described using FIG. 5D. FIG. 5D is a CNN that includes a class classification SVM as the output of the fully connected layer FL[1]. In FIG. 5D, the output PO1 is output from the pooling layer PL[3]. The output PO1 is a feature value where a feature value is extracted by the convolutional layer CL and positional information of the feature value is reduced. Accordingly, the output PO1 corresponds to the feature value Code1 to the feature value Code4. Alternatively, the feature value generated using the output FO2 that is a class classification result in addition to the output PO1 or the output FO1 may be the feature value Code1 to the feature value Code4. When the class classification SVM is included, the output FO2 has a classification function depending on the feature value.

The structures illustrated in FIG. 5A to FIG. 5D can be used in combination with each other as appropriate.

FIG. 6 is a diagram showing the database 11f included in the storage portion 11e. Note that the database 11f can also be referred to as an image retrieval database. The database 11f includes the list 30 to the list 34. The list 30 has unique numbers (No). The list 31 has the feature values Code1. The list 32 has the feature values Code2. The list 33 has image file names. The list 34 has Flags.

For example, the case where the number (No) is “1” is described. In the feature value Code1, 9216 numbers including decimal points are registered as the output PO1. In the feature value Code2, 82994 numbers including decimal points are registered as the maximum output PO1. In the image file name, an image SImage(1) is registered. In Flag, “1” is registered.

As another example, the case where the number (No) is “3” is described. Feature values have not been registered in the feature value Code1 and the feature value Code2. In the image file name, SImage(3) is registered. In Flag, “0” is registered. In other words, it shows that in the case where the number (No) is “3,” the control portion 11a registers only an image and extracts neither the feature value Code1 nor the feature value Code2 because the arithmetic processing capability of the server computer 11 decreases. Note that in the case where the arithmetic processing capability of the server computer 11 has a margin, the image SImage(3) is selected by the control portion 11a, the feature value Code1 and the feature value Code2 are extracted by the code generation portion 11c and are registered in the list 31 or the list 32, and “1” is registered in the list 34.

Note that the database 11f may register the number of pixels of an image to be registered in the list 33 instead of the feature value Code2.

For example, in the second selection mode, a feature value Code5 (not illustrated) is extracted by the code generation portion 11c from the image SImage. Next, after the number of pixels of the query image SPImage is resized and converted into a fourth query image with the same number of pixels as the image SImage by the code generation portion 11c, a feature value Code6 (not illustrated) is extracted from the fourth query image.

The image selection portion 11d compares the feature value Code6 and the feature values Code5 of the plurality of images SImage selected in the first selection mode. The image SImage having the highest similarity with the feature value Code6 or the list (List3) of the plurality of images SImage each having high similarity is displayed as a query response. When the query image has the same number of pixels as an image registered in the database 11f, an image having more precise similarity can be retrieved.

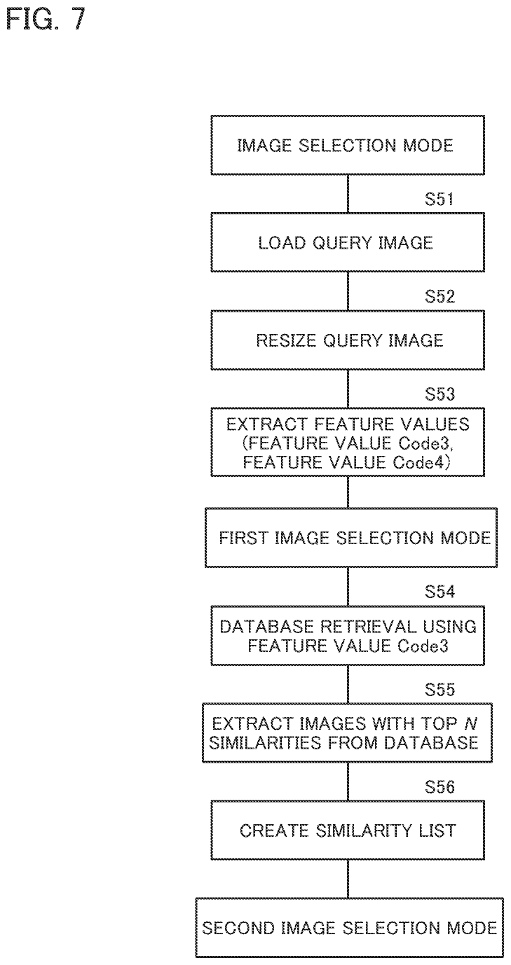

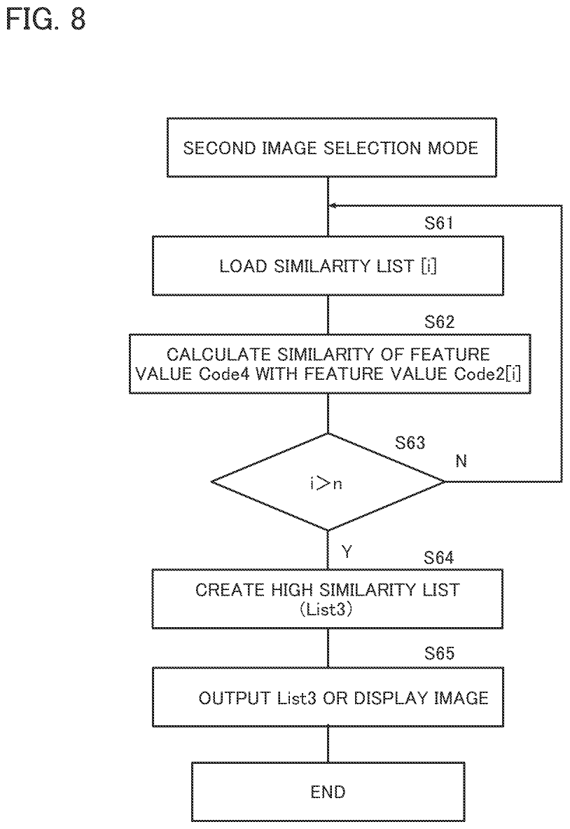

FIG. 7 is a flow chart showing the image selection mode and the first selection mode. The image selection mode includes Step S51 to Step S53, and a first image selection mode includes Step S54 to Step 56. FIG. 8 is a flow chart showing a second image selection mode. The second image selection mode includes Step S61 to Step 65. Note that in FIG. 7 and FIG. 8, the query image SPImage is displayed as a query image, and the image SImage is displayed as an image.

First, the image selection mode is described. Step S51 is a step of loading the query image into the image retrieval device 10. To make a detailed description, in the image retrieval device 10, the query image SPImage is loaded into the code generation portion 11c from the computer 21 through the network 18. Note that the computer 21 may be an information terminal.

In Step S52, the query image SPImage is resized by the code generation portion 11c. The number of pixels of the query image SPImage is resized and converted into the number of pixels of the second query image by the code generation portion 11c, and the number of pixels of the query image SPImage is resized and converted into the number of pixels of the third query image by the code generation portion 11c.

In Step S53, the feature value Code3 (not illustrated) is extracted from the second query image by the code generation portion 11c, and the feature value Code4 (not illustrated) is extracted from the third query image by the code generation portion 11c.

Next, the first image selection mode is described. In Step S54, the image SImage with high similarity with the feature value Code3 is selected by the image selection portion 11d from the feature values Code1 of the plurality of images SImage registered in the database 11f. Note that the feature value Code3 is preferably a feature value whose size is the same as that of the feature value Code1.

In Step S55, top n images with high similarities out of the plurality of images SImage selected in the first selection mode are selected.

In Step S56, a similarity list of the top n images with high similarities selected in Step S55 in descending order of similarity is created. Therefore, the similarity list includes n components. Then, the process moves to the second image selection mode.

FIG. 8 is a flow chart showing the second image selection mode. In Step S61, i-th registration information in the similarity list of the n images is loaded by the image selection portion 11d from the database 11f.

In Step S62, similarities of the feature values Code4 with the feature values Code2 of the plurality of images SImage selected in the first selection mode are calculated by the image selection portion 11d using, for example, cosine similarity.

In Step S63, in the case where i is less than or equal to n (N), the process moves to Step S61, and [i+1]th registration information in the similarity list is loaded from the database 11f. Note that in the case where i is greater than n (Y), the process moves to Step S64.

In Step S64, the control portion 11a creates the list (List3) of high similarity. In the list of high similarity, it is preferable to display sorted images with high similarities. Note that in the list, top k images with high similarities in the list can be set as a selection range by the user. Note that it is preferable that the selection range can be set by the user freely. Note that k is an integer greater than or equal to 1.

In Step S65, the list of high similarity is displayed on the computer 21 through a network as a query response by the control portion 11a. Note that the list of high similarity may be displayed as the query response, or the image SImage corresponding to the list of high similarity may be displayed as the query response.

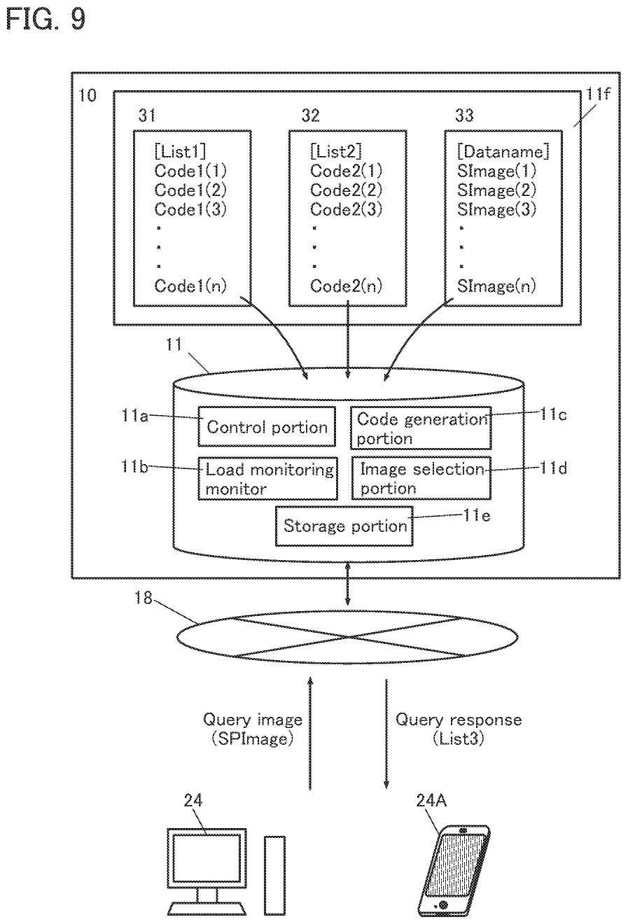

FIG. 9 is a diagram illustrating an image retrieval method that is different from the image retrieval method in FIG. 2. For example, in FIG. 9, the query image SPImage is supplied to the server computer 11 from a computer 24 or an information terminal 24A through the network 18. Note that the query response can be displayed on either one or both the computer 24 and the information terminal 24A from the server computer 11 through the network 18. In other words, in the image retrieval method, a terminal for transmitting the query image SPImage may be different from a terminal for receiving the query response.

For example, the image retrieval method according to one embodiment of the present invention can be used for a surveillance camera system. A person taken with the surveillance camera can be retrieved in a database, and a retrieval result can be transmitted to an information terminal or the like.

The structures illustrated in one embodiment of the present invention can be used in an appropriate combination.

### REFERENCE NUMERALS

:10: image retrieval device, 11: server computer, 11a: control portion, 11b: load monitoring monitor, 11c: code generation portion, 11d: image selection portion, 11e: storage portion, 11f: database, 18: network, 20: computer, 21: computer, 20A: information terminal, 22: storage portion, 22A: storage portion, 23: image, 23A: image, 24: computer, and 24A: information terminal.

1. An image retrieval method for retrieving an image with high similarity by using a query image,
wherein the image retrieval method is performed using a control portion, a code generation portion, an image selection portion, and a storage portion,
wherein the image retrieval method includes an image registration mode and an image selection mode,
wherein the image registration mode includes a step of supplying a first image to the code generation portion; a step in which the code generation portion resizes the number of pixels of the first image and converts the number of pixels of the first image into the number of pixels of a second image; a step in which the code generation portion extracts a first feature value from the second image; and a step in which the control portion links the first image to the first feature value corresponding to the first image and stores the first image and the first feature value in the storage portion, and
wherein the image selection mode includes a step of supplying a first query image to the code generation portion; a step in which the code generation portion resizes the number of pixels of the first query image and converts the number of pixels of the first query image into the number of pixels of a second query image; a step in which the code generation portion extracts a second feature value from the second query image; and a step in which the image selection portion selects the first image having the first feature value with high similarity with the second feature value and displays the selected first image or a list of the selected first images as a query response.

2. An image retrieval method for retrieving an image with high similarity by using a query image,
wherein the image retrieval method is performed using a control portion, a code generation portion, an image selection portion, and a storage portion,
wherein the image retrieval method includes an image registration mode and an image selection mode,
wherein the image selection mode includes a first selection mode and a second selection mode,
wherein the image registration mode includes a step of supplying a first image to the code generation portion; a step in which the code generation portion resizes the number of pixels of the first image, converts the number of pixels of the first image into the number of pixels of a second image, and extracts a first feature value from the second image; a step in which the code generation portion resizes the number of pixels of the first image, converts the number of pixels of the first image into the number of pixels of a third image, and extracts a second feature value from the third image; and a step in which the control portion links the first image to the first feature value and the second feature value corresponding to the first image and stores the first image, the first feature value, and the second feature value in the storage portion,
wherein the image selection mode includes a step of supplying a first query image to the code generation portion; a step in which the code generation portion resizes the number of pixels of the first query image, converts the number of pixels of the first query image into the number of pixels of a second query image, and extracts a third feature value from the second query image; a step in which the code generation portion resizes the number of pixels of the first query image, converts the number of pixels of the first query image into the number of pixels of a third query image, and extracts a fourth feature value from the third query image; and a step of executing the first selection mode and the second selection mode,
wherein the first selection mode includes a step in which the image selection portion compares the third feature value and the first feature value and a step in which the image selection portion selects the plurality of first images each having the first feature value with high similarity with the third feature value,
wherein the second selection mode includes a step in which the image selection portion compares the fourth feature value and the second feature value of the plurality of first images selected in the first selection mode, and
wherein the image selection mode includes a step in which the control portion displays the first image having the highest similarity with the fourth feature value or a list of the plurality of first images each having high similarity as a query response.

3. The image retrieval method according to claim 2, wherein the number of pixels of the third image is larger than the number of pixels of the second image.

4. The image retrieval method according to claim 1, wherein the code generation portion includes a convolutional neural network.

5. The image retrieval method according to claim 4,
wherein the convolutional neural network included in the code generation portion includes a plurality of max pooling layers, and
wherein the first feature value or the second feature value is an output of any one of the plurality of max pooling layers.

6. The image retrieval method according to claim 5,
wherein the convolutional neural network includes a plurality of fully connected layers,
wherein the first feature value or the second feature value is an output of any one of the plurality of max pooling layers or an output of any one of the plurality of fully connected layers.

7. An image retrieval system comprising:
a memory for storing a program for performing the image retrieval method according to claim 1, and
a processor for executing the program.

8. An image retrieval system comprising, in a server computer, a memory for storing a program for performing the image retrieval method according to claim 1, wherein the query image is supplied from an information terminal through a network.

9. An image retrieval system operating on a server computer where an image supplied through a network is registered,
wherein the image retrieval system includes a control portion, a code generation portion, a database, and a load monitoring monitor,
wherein the load monitoring monitor is configured to monitor arithmetic processing capability of the server computer,
wherein the image retrieval system has a first function and a second function,
wherein in the case where the arithmetic processing capability has no margin, the first function makes the control portion register the image supplied through the network in the database, and
wherein in the case where the arithmetic processing capability has a margin, the second function makes the code generation portion extract a feature value from the image and makes the control portion register the image and the feature value corresponding to the image in the database, or the second function makes the control portion extract the feature value of the image that has not been registered from the image that has been registered in the database and makes the control portion register the feature value of the image in the database.

10. The image retrieval method according to claim 2, wherein the code generation portion includes a convolutional neural network.

11. The image retrieval method according to claim 10,
wherein the convolutional neural network included in the code generation portion includes a plurality of max pooling layers, and
wherein the first feature value or the second feature value is an output of any one of the plurality of max pooling layers.

12. The image retrieval method according to claim 11,
wherein the convolutional neural network includes a plurality of fully connected layers,
wherein the first feature value or the second feature value is an output of any one of the plurality of max pooling layers or an output of any one of the plurality of fully connected layers.
